(19) United States
(12) Patent Application Publication
(10) Pub. No.: US 2024/0138538 A1
(43) Pub. Date: May 2, 2024

(54) HAIR DRYER

(71) Applicant: LG ELECTRONICS INC., Seoul (KR)

(72) Inventors: Kyoungtae KIM, Seoul (KR); Hyunchul KIM, Seoul (KR); Yunhee KU, Seoul (KR); Rayoung PARK, Seoul (KR); Dongwon KIM, Seoul (KR); Taegil CHO, Seoul (KR)

(73) Assignee: LG ELECTRONICS INC., Seoul (KR)

(21) Appl. No.: 18/270,809

(22) PCT Filed: Jan. 3, 2022
(86) PCT No.: PCT/KR2022/000008

§ 371 Date: Jul. 3, 2023

(30) Foreign Application Priority Data
Jan. 4, 2021 (KR) 10-2021-0000332

(51) Int. Cl. A45D 20/12

(52) U.S. Cl. CPC A45D 20/122

(57) ABSTRACT

A hairdryer may be provided, the hairdryer comprising: a main body unit provided with a gas discharge unit through which a gas is discharged to the outside, and a handle unit extending from the main body unit, wherein the gas discharge unit comprises: a module power supply unit which is provided at the center of the gas discharge unit and is in contact with a diffuser coupled to the main body so as to supply electric power to the diffuser; and a coupling unit which is provided in an annular shape along the circumference of the gas discharge unit so as to surround the module power supply unit. The diffuser is coupled to the main body unit via the coupling unit, and the module power supply unit is provided to come into contact with the diffuser while facing the diffuser. As such, a user may easily couple the diffuser to the hairdryer. Also, the hairdryer can supply electric power to the diffuser so that the additional function of the diffuser can be easily carried out. That is, user's convenience can be improved.

### TECHNICAL FIELD

The present disclosure relates to a hair dryer, and more particularly, a hair dryer from which gas introduced into a gas inlet is discharged via a gas discharger.

### BACKGROUND

When human hair is dried as desired from a wet state or styled from a current shape to a desired shape, a hair dryer that discharges gas via a gas discharger may be used.

When a user dries hair with the hair dryer in a situation in which the hair is wet, the hair dryer may provide gas characteristics desired by the user, such as a gas temperature, a gas speed, a gas flow area, and the like.

Accordingly, a diffuser having various shapes may be coupled to the hair dryer to provide gas with the characteristics desired by the user. Furthermore, the hair dryer may perform additional functions such as anion care and LED care in addition to the function of drying the hair. The above-mentioned additional functions may be provided to the user by being equipped in the diffuser that is coupled to the hair dryer.

However, when the diffuser that performs additional functions such as the anion care and the LED care is coupled to the hair dryer, the hair dryer must supply power to the diffuser for the additional functions to be performed.

Accordingly, there is an increasing demand for the hair dryer that may be coupled with the diffuser regardless of a coupling direction of the diffuser (a rotation direction with a virtual line passing through a center of the diffuser as a rotation axis) that performs the additional functions for user convenience.

Furthermore, there is a growing demand for the hair dryer in which the power may be supplied to the diffuser that performs the additional functions regardless of the coupling direction of the diffuser that performs the additional functions.

### SUMMARY

### Technical Problem

Embodiments of the present disclosure are to provide a hair dryer that is easy to be coupled to a diffuser.

Embodiments of the present disclosure are to provide a hair dryer in which a module power supply may supply power to a diffuser regardless of a direction of one surface where the diffuser is coupled to the hair dryer (a rotation direction using a virtual line passing through a center of the diffuser as a rotation axis).

Embodiments of the present disclosure are to provide a hair dryer in which additional functions of a diffuser are performed as power is supplied to the diffuser when the diffuser is coupled to a main body.

### Technical Solutions

An example for solving the above-mentioned problem is to provide a hair dryer to which a diffuser may be coupled regardless of a coupling direction (a rotation direction using a virtual line passing through a center of the diffuser as a rotation axis) of one surface where the diffuser is coupled to the hair dryer.

Furthermore, an example for solving the above-mentioned problem is to provide a hair dyer in which power is supplied to a diffuser regardless of a coupling direction (a rotation direction using a virtual line passing through a center of the diffuser as a rotation axis) of one surface where the diffuser is coupled to the hair dryer. Furthermore, it is to provide a hair dryer that supplies power to a diffuser and performs additional functions of the diffuser when the diffuser is coupled thereto.

According to the present embodiments, a hair dryer includes a main body having a gas discharger configured to discharge gas, and a handle disposed on the main body, the gas discharger includes a module power supply located at a center of the gas discharger and configured to supply power to a diffuser coupled to the main body, and a coupling portion surrounding the module power supply and formed in an annular shape along a circumference of the gas discharger, the diffuser is coupled to the main body via the coupling portion, and the module power supply faces the diffuser and is in contact with the diffuser to supply power to the diffuser.

Furthermore, the gas discharger may further include a coupling auxiliary portion disposed between the coupling portion and the module power supply and formed in an annular shape to surround the module power supply, and a gas discharge hole defined between the coupling auxiliary portion and the coupling portion, wherein gas is discharged via the gas discharge hole.

Furthermore, the gas discharger may be disposed at a front side of the main body, the module power supply may include a first power supply terminal disposed at the center of the gas discharger and protruding forward, and a second power supply terminal spaced apart from the first power supply terminal and formed in an annular shape to surround the first power supply terminal, and the first power supply terminal may have a first polarity, and the second power supply terminal may have a second polarity different from the first polarity.

Furthermore, the module power supply may further include a gas discharge auxiliary hole defined between the first power supply terminal and the second power supply terminal, wherein gas is discharged via the gas discharge auxiliary hole.

Furthermore, the diffuser may include a housing forming an outer appearance of the diffuser, a gas inlet disposed at one side of the housing, wherein gas is introduced into the gas inlet from the gas discharger, and a module disposed inside the housing and operated by receiving power from the module power supply, the gas inlet may include a module power receiver in contact with the module power supply to transmit received power to the module, and a receiving portion disposed at a center of the gas inlet, wherein the module power receiver is received in the receiving portion, and the module power receiver may have an end facing the module power supply, wherein the end extends through the receiving portion to be in contact with the module power supply.

Furthermore, the module power supply may include a first power supply terminal disposed at the center of the gas discharger, protruding toward the receiving portion, and having a first polarity, and a second power supply terminal spaced apart from the first power supply terminal, formed in an annular shape to surround the first power supply terminal, and having a second polarity different from the first polarity, and the module power receiver may include a first power receiving terminal disposed at a position corresponding to the first power supply terminal and in contact with the first power supply terminal, and a second power receiving terminal disposed at a position corresponding to the second power supply terminal and in contact with the second power supply terminal.

Furthermore, the receiving portion may further include a first receiving portion providing a space for the first power receiving terminal to be received, and a second receiving portion disposed to surround the first receiving portion and providing a space for the second power receiving terminal to be received, the first receiving portion may include a first receiving circumferential wall extending from one surface of the first receiving portion facing the first power supply terminal to a position between the first power receiving terminal and the second power receiving terminal, and the first power receiving terminal may be prevented from being in contact with the second power receiving terminal by the first receiving circumferential wall.

Furthermore, the first power supply terminal may decrease in a diameter as a distance to the first receiving portion is reduced, the first receiving portion may include a receiving recessed portion recessed to correspond to the first power supply terminal from the one surface of the first receiving portion facing the first power supply terminal, and at least a portion of the first power supply terminal may be inserted into the receiving recessed portion.

Furthermore, the first power receiving terminal may include a first receiving terminal main body formed in an annular shape, a first receiving terminal extension extending from the first receiving terminal main body toward the first power supply terminal, and a first receiving terminal contact portion formed to be curved from an end of the first receiving terminal extension toward the first receiving terminal main body, the first receiving portion may include a first contact hole defined through the one surface of the first receiving portion facing the first power supply terminal, and the first receiving terminal contact portion may be in contact with the first power supply terminal via the first contact hole.

Furthermore, the second power receiving terminal may include a second receiving terminal main body disposed to surround at least a portion of the first power receiving terminal, a second receiving terminal extension extending from the second receiving terminal main body toward the second power supply terminal, and a second receiving terminal contact portion formed to be curved from an end of the second receiving terminal extension toward the second receiving terminal main body, the second receiving portion may include a second contact hole defined through one surface of the second receiving portion facing the second power supply terminal, and the second receiving terminal contact portion may be in contact with the second power supply terminal via the second contact hole.

Furthermore, the gas discharger may further include a sensor assembly disposed inside the first power supply terminal and sensing coupling of the diffuser and the main body by sensing magnetism generated by the diffuser, the diffuser may include a recognizing magnetic body receiving portion disposed at a center of the first receiving portion, and a recognizing magnetic body received in the recognizing magnetic body receiving portion and having magnetism, the recognizing magnetic body receiving portion may be disposed between the first power receiving terminal and the recognizing magnetic body, the recognizing magnetic body may be prevented from being in contact with the first power receiving terminal by the recognizing magnetic body receiving portion, and the sensor assembly may sense magnetism of the recognizing magnetic body.

Furthermore, the first power receiving terminal may include a plurality of first receiving terminal contact portions disposed along a circumference of the first receiving portion and in contact with the first power supply terminal, the second power receiving terminal may include a plurality of second receiving terminal contact portions disposed along a circumference of the second receiving portion and in contact with the second power supply terminal, and the first receiving terminal contact portions and the second receiving terminal contact portions may be disposed side by side along a radial direction of the gas inlet.

Furthermore, the diffuser may be coupled to the main body to be rotatable using a virtual line passing through the center of the gas inlet and heading toward the module power supply as a rotation axis.

Furthermore, the module may include a plurality of lamps spaced apart from a center of the module in a radial direction of the module, and the lamp may be turned on by receiving power from the module power receiver.

Furthermore, the gas inlet may further include a main body coupling portion formed in an annular shape along a circumference of the gas inlet to surround the receiving portion and disposed at a position corresponding to the coupling portion, and a coupling magnetic body formed in an annular shape in the main body coupling portion and coupled to the coupling portion by a magnetic force.

Furthermore, the main body coupling portion may include a coupling magnetic body receiving portion defined as one surface of the main body coupling portion facing the coupling portion is recessed, and the coupling magnetic body receiving portion may receive the coupling magnetic body therein.

### Advantageous Effects

According to the embodiments of the present disclosure, the user may easily couple the diffuser to the hair dryer.

Furthermore, according to the embodiments of the present disclosure, the diffuser may be easily supplied with the power by the module power supply when the diffuser that performs the additional functions and the hair dryer are coupled to each other.

Furthermore, according to the embodiments of the present disclosure, the additional functions of the diffuser may be easily performed as the diffuser is easily supplied with the power by the module power supply when the diffuser that performs the additional functions and the hair dryer are coupled to each other.

### BRIEF DESCRIPTION OF THE DRAWINGS

FIG. 1 is a perspective view of a hair dryer according to one embodiment of the present disclosure to which a diffuser is not coupled.

FIG. 2 is a view showing an internal cross-section of a hair dryer shown in FIG. 1.

FIG. 3 is a view showing a diffuser according to an embodiment of the present disclosure.

FIG. 4 is a perspective view of a hair dryer coupled with a diffuser according to an embodiment of the present disclosure.

FIG. 5 is a view showing a main body according to one embodiment of the present disclosure.

FIG. 6 is a view showing a main body having a gas discharge auxiliary hole defined therein according to an embodiment of the present disclosure.

FIG. 7 is a view showing a diffuser according to an embodiment of the present disclosure.

FIG. 8 is a view showing a module power receiver of a diffuser according to an embodiment of the present disclosure.

FIG. 9 is a view showing a portion where a main body and a diffuser are coupled to each other according to an embodiment of the present disclosure.

FIG. 10 is a view showing a hair dryer in which additional functions are performed by a diffuser according to an embodiment of the present disclosure.

### DETAILED DESCRIPTION

Hereinafter, embodiments of the present disclosure will be described in detail with reference to the accompanying drawings so that the present disclosure may be easily realized by those skilled in the art.

However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the present specification, redundant descriptions of the same components are omitted.

It will be understood that, when an element is referred to as being “connected to” another element, the element can be connected to the other element or intervening elements may also be present. In contrast, when an element is referred to as being “directly connected to” another element, there are no intervening elements present.

Specific terminology used in this specification is only for convenience of description and is not intended to be limiting of the illustrative embodiments.

A singular representation may include a plural representation unless it represents a definitely different meaning from the context.

In description of the present disclosure, the terms “comprising,” “including,” and “having” shall be understood to designate the presence of particular features, numbers, steps, operations, elements, parts, or combinations thereof, but not to preclude the presence or addition of one or more other features, numbers, steps, operations, elements, parts, or combinations thereof.

In description of the present disclosure, the term “and/or” may include a combination of a plurality of items or any one of a plurality of listed items. For example, “A or B” may include “only A”, “only B”, and/or “both A and B”.

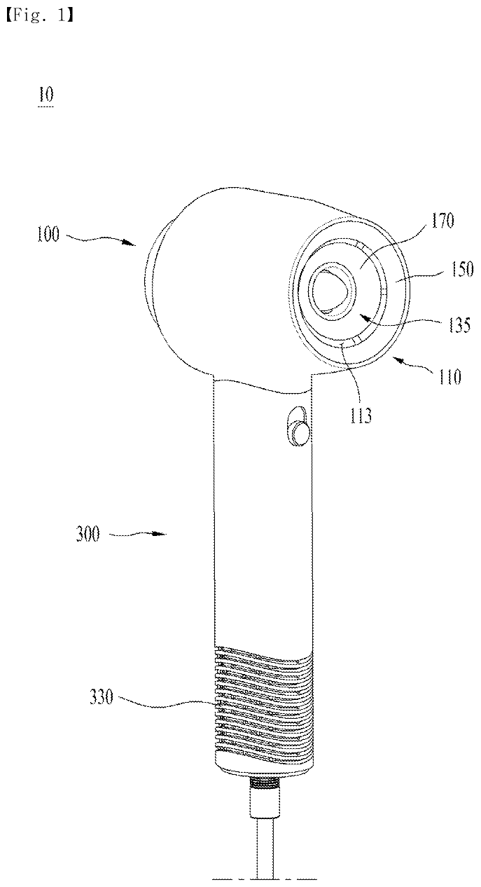

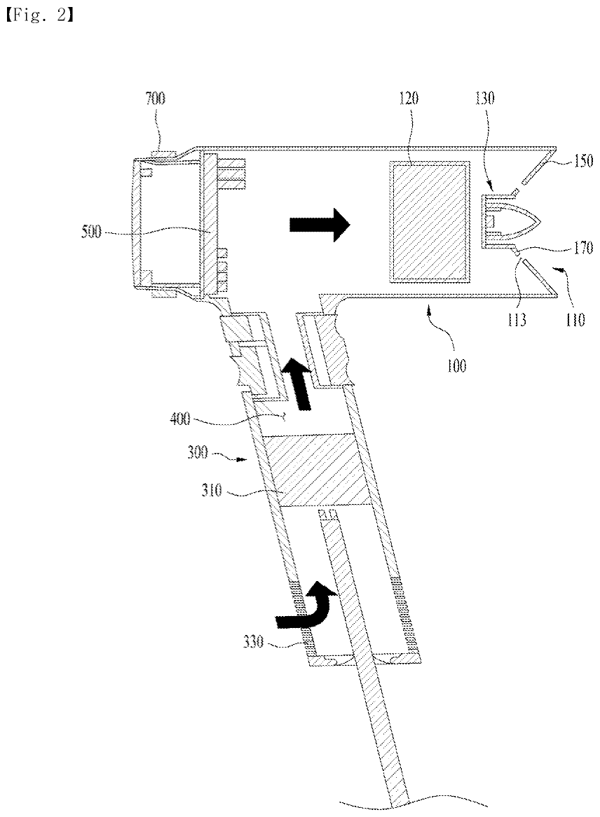

FIG. 1 is a perspective view of a hair dryer from which a diffuser is removed according to one embodiment of the present disclosure, and FIG. 2 is a view showing an internal cross-section of a hair dryer shown in FIG. 1. A hair dryer according to one embodiment of the present disclosure includes a main body 100, a handle 300, and a gas discharger 110 as shown in FIGS. 1 and 2.

As shown in FIG. 2, the main body 100 may have a gas flow channel 400 defined therein through which gas flows, and have the gas discharger 110 through which internal gas is discharged to the outside. The main body 100 may have a shape extending in a front and rear direction and may have various cross-sectional shapes such as a circular or a polygonal shape when viewed from the front.

In the present disclosure, definitions of front, rear, left, right, upper, and lower sides may be centered on the main body 100. For example, referring to FIG. 2, the gas discharger 110 may be disposed at a front side of the main body 100, and the handle 300 may have a shape extending substantially downward from the main body 100.

Gas flowing inside the main body 100 may be introduced through a main gas inlet 330, and the main gas inlet 330 may be defined in the main body 100 or the handle 300. When the main gas inlet 330 is defined in the handle 300, the gas flow channel 400 may extend from the handle 300 to the main body 100. That is, the gas flow channel 400 may extend from the main gas inlet 330 to the gas discharger 110.

Gas may be introduced from the outside via the main gas inlet 330 defined in the main body 100 or the handle 300, and gas introduced to the inside may flow along the gas flow channel 400 and be discharged to the outside via the gas discharger 110 disposed at the main body 100.

The handle 300 may extend from the main body 100. FIGS. 1 and 2 show the handle 300 extending downward from the main body 100. The handle 300 may be integrally molded with the main body 100 or manufactured separately and coupled to the main body 100.

When the handle 300 is manufactured separately from the main body 100 and coupled to the main body 100, the handle 300 may be formed such that a longitudinal direction with respect to the main body 100 is fixed or variable.

For example, the handle 300 may have a hinge coupling portion, and may be coupled to the main body 100 such that the longitudinal direction of the handle 300 may be changed, that is, the handle 3X) may be foldable with respect to the main body 100.

The handle 300 may be a portion gripped by a user with hand, and thus, may have a shape to improve grip convenience. There may be various extension directions of the handle 300, but for convenience of description, the direction in which the handle 300 extends from the main body 100 is the downward direction.

Referring to FIG. 2, the hair dryer according to one embodiment of the present disclosure includes a fan unit 310 that may allow gas to flow and adjust a speed of gas discharged via the gas discharger 110. The fan unit 310 may be disposed in the gas flow channel 400 to allow gas to flow, and may be disposed inside the main body 100 or inside the handle 300.

For example, when the main gas inlet 330 is defined in the handle 300, the gas flow channel 400 may extend from the main gas inlet 330 of the handle 300 to the gas discharger 110 of the main body 100, and the fan unit 310 may be disposed in the gas flow channel 400 located inside the handle 300.

Furthermore, a temperature adjust unit 120 that may adjust a temperature of discharged gas may be disposed inside the main body 100. FIG. 2 schematically shows the temperature adjust unit 120 disposed inside the main body 100.

Furthermore, the temperature adjust unit 120 may be of various types. The temperature adjust unit 120 may be in a scheme of heating gas by providing current to a resistor in a form of a coil to generate heat.

However, the resistor of the temperature adjust unit 120 may not necessarily be in the form of the coil, and may be of various types that may heat gas or adjust the temperature of gas using, for example, a thermoelectric element.

A schematic description of an operation scheme of the hair dryer according to one embodiment of the present disclosure along with the gas flow is as follows.

First, the user manipulates a power button disposed on the main body 100 or the handle 300. When the power button is pressed, the fan unit 310 operates and gas is introduced into the hair dryer via the main gas inlet 330.

Gas introduced via the main gas inlet 330 flows along the gas flow channel 400 by the fan unit 310 toward the gas discharger 110, and gas is discharged from the gas discharger 110 and provided to the user.

In such process, the flow speed of gas in the gas flow channel 400 may be adjusted by the fan unit 310 and the temperature of gas may be adjusted by the temperature adjust unit 120. Adjustment of operation states of the fan unit 310 and the temperature adjust unit 120 may be performed by the user manipulating a manipulation unit 500, or may be automatically performed based on an operation mode preset in a controller 700.

In one example, the user may dry hair using gas discharged via the gas discharger 110 of a hair dryer 10. However, a diffuser 200 may be coupled to the main body 100 to provide gas having characteristics (the gas temperature, the gas speed, and a gas flow area) desired by the user. Furthermore, the diffuser 200 that may allow additional functions such as anion care function and an LED care function to be performed may be coupled.

Accordingly, the hair dryer 10 according to one embodiment of the present disclosure may be coupled to the diffuser 200 of various shapes.

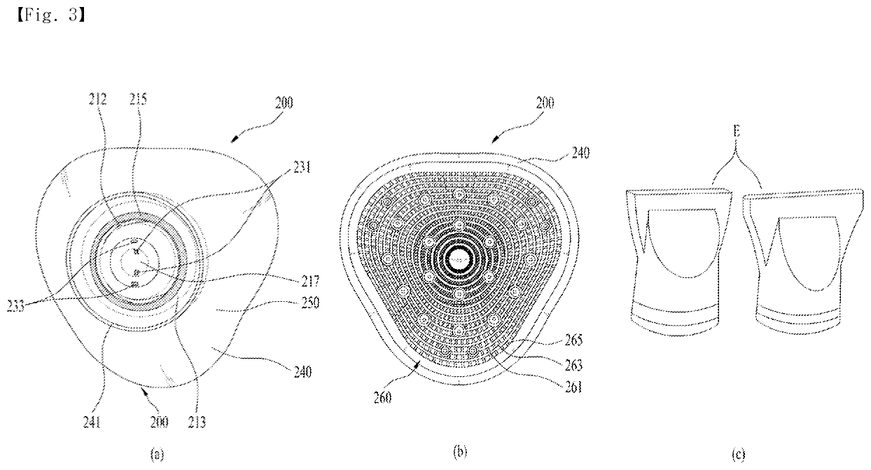

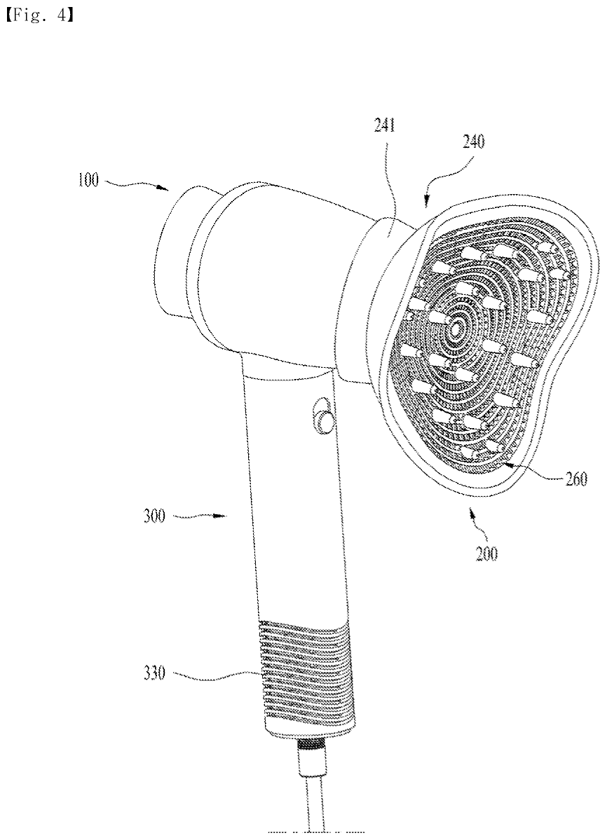

FIG. 3 is a view showing a diffuser according to an embodiment of the present disclosure. FIG. 4 is a perspective view of a hair dryer coupled with a diffuser according to an embodiment of the present disclosure.

Specifically, (a) in FIG. 3 shows one surface coupled to the main body of the diffuser that may perform the LED care function, and (b) in FIG. 3 shows the other surface of the diffuser shown in (a) in FIG. 3 through which gas is discharged. (c) in FIG. 3 shows a diffuser with various flow channels therein.

Referring to FIGS. 3 and 4, the hair dryer 10 according to one embodiment of the present disclosure may be coupled with the diffuser 200 of the various shapes. As shown in (c) in FIG. 3, the hair dryer 10 may be coupled with a diffuser E that is not equipped with the additional functions, but has various shapes of a gas outlet through which gas is discharged. Furthermore, as shown in (a) and (b) in FIG. 3, the hair dryer 10 may be coupled with the diffuser 200 including a module 250 that performs the additional functions. That is, the diffuser 200 may perform a scalp and hair care function using LEDs, a scalp and hair care function using anions, and the like via the module unit 250.

However, when the diffuser 200 including the module 250 that performs the additional functions is coupled thereto, the hair dryer 10 may need to supply power to the diffuser 200. That is, the diffuser 200 may require the power to turn on LEDs or generate anions.

In other words, the hair dryer 10 may require easy coupling of the diffuser 200 including the module 250 that performs the additional functions. Furthermore, the hair dryer 10 may require the easy coupling of the diffuser 200 and easy supply of the power to the diffuser 200.

Accordingly, the hair dryer 10 according to one embodiment of the present disclosure may include a module power supply 135 disposed at a center of the main body 100 and in contact with the diffuser 200 to supply the power to the diffuser 200. Furthermore, the hair dryer 10 may include a coupling portion 150 formed in an annular shape to surround the module power supply 135.

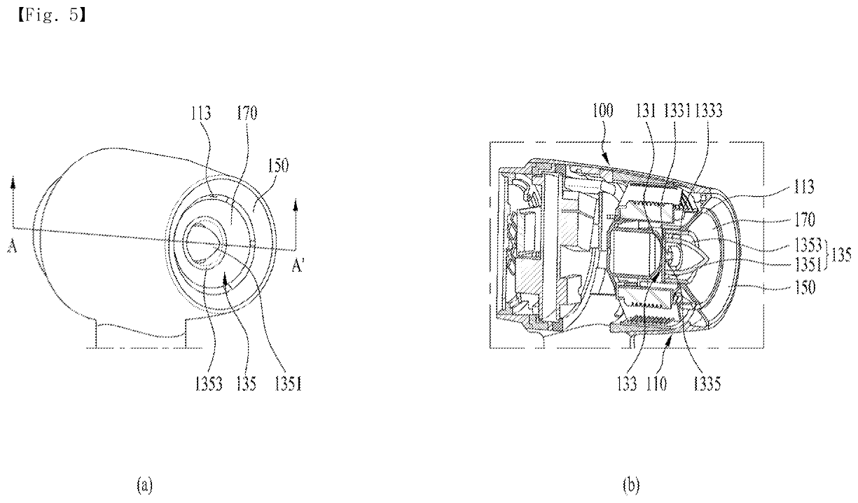

FIG. 5 is a view showing a main body according to one embodiment of the present disclosure. Specifically, (a) in FIG. 5 is an enlarged view of the main body, and (b) in FIG. 5 is a cross-sectional view of the main body.

Referring to FIGS. 1 and 5, the hair dryer 10 according to one embodiment of the present disclosure may include the main body 100 having the gas discharger 110 through which gas is discharged to the outside. Furthermore, the hair dryer 10 may include the handle 300 extending from the main body 100. The main body 100 may be extended in a cylindrical shape. Furthermore, the main body 100 may include the gas discharger 110 through which gas is discharged by opening a front side of the main body 100.

The gas discharger 110 may include the module power supply 135 disposed at the center of the gas discharger 110. The module power supply 135 may supply the power to the diffuser 200 that is coupled to the main body 100. The module power supply 135 may be disposed in contact with the diffuser 200 to supply the power to the diffuser 200. Furthermore, the gas discharger 110 may include the coupling portion 150 formed in the annular shape along a circumference of the gas discharger 110 to surround the module power supply 135. That is, the diffuser 200 may be coupled to the main body 100 via the coupling portion 150.

The coupling portion 150 may be disposed at an outermost side of the gas discharger 110 and be in contact with an inner circumferential surface of the main body 100. Accordingly, the coupling portion 150 may be supported by the inner circumferential surface of the main body 100. Furthermore, the coupling portion 150 may be disposed at the outermost side of the gas discharger 110 to maximally secure a size of an area coupled to the diffuser 200.

As the coupling portion 150 is formed in the annular shape, the diffuser 200 may be coupled to the main body 100 via the coupling portion 150 independently of a coupling direction of the diffuser 200. The meaning of the diffuser 200 being coupled to the main body 100 via the coupling portion 150 independently of the coupling direction of the diffuser 200 is as follows. A rotation axis passing through the center of the main body 100 and a rotation axis passing through a center of the diffuser 200 may be the same. Furthermore, the diffuser 200 may be coupled to the main body 100 regardless of a rotation angle based on the rotation axis. That is, the diffuser 200 may rotate 360 degrees while being coupled to the main body 100. To sum up, the coupling of the diffuser 200 and the main body 100 may be achieved non-directionally.

Accordingly, the module power supply 135 disposed at the center of the gas discharger 110 may be disposed to face the diffuser 200. Specifically, the module power supply 135 may be in contact with the diffuser 200 at the center of the diffuser 200 when the diffuser 200 is coupled thereto. Accordingly, the diffuser 200 may be coupled to the main body 100 independently of the coupling direction of the diffuser 200, and the module power supply 135 may supply the power to the diffuser 200 independently of the coupling direction of the diffuser 200. A detailed relationship between the module power supply 135 and the diffuser 200 will be described later.

In one example, referring back to FIGS. 1 and 5, in the hair dryer 10 according to one embodiment of the present disclosure, the gas discharger 110 may further include a coupling auxiliary portion 170.

Specifically, the gas discharger 110 may include the coupling auxiliary portion 170 disposed between the coupling portion 150 and the module power supply 135. The coupling auxiliary portion 170 may be formed in an annular shape to surround the module power supply 135. The coupling auxiliary portion 170 may accommodate a portion of the diffuser 200 therein when the diffuser 200 is coupled. Accordingly, the coupling auxiliary portion 170 may further support the diffuser 200 in addition to the coupling of the diffuser 200 via the coupling portion 150. As a result, the diffuser 200 may be coupled to the main body 100 by receiving a great coupling force.

Furthermore, the gas discharger 110 may include a gas discharge hole 113 defined between the coupling auxiliary portion 170 and the coupling portion 150. Gas introduced via the main gas inlet 330 may pass through the main body 100 and be discharged to the outside via the gas discharge hole 113. That is, the hair dryer 10 may perform a basic function of drying the user's hair even when the diffuser 200 is not coupled thereto.

However, when an entirety of the gas discharger 110 is opened, a large amount of heated gas may be discharged via the gas discharger 110, and the hair or scalp of the user may be damaged. Furthermore, when the entirety of the gas discharger 110 is opened, it may be difficult for the user to dry the hair with a gentle flow of gas. Accordingly, a size of the gas discharge hole 113 may be adjusted by adjusting sizes of the coupling auxiliary portion 170 and the coupling portion 150. Thus, the user may dry the hair using the gentle flow of gas discharged via the gas discharge hole 113. Furthermore, the user may prevent damage to the hair and the scalp as much as possible by a flow rate adjusted via the gas discharge hole 113.

In one example, temperatures of the coupling portion 150 and the coupling auxiliary portion 170 may be increased by heated gas. When the coupling portion 150 and the coupling auxiliary portion 170 protrude forward, a probability that the user comes into contact with the coupling portion 150 and the coupling auxiliary portion 170 may increase, thereby increasing a risk of burns and injury. Accordingly, the coupling portion 150 and the coupling auxiliary portion 170 may be curved so as to be recessed rearward toward the module power supply 135. That is, the coupling portion 150 and the coupling auxiliary portion 170 may be prevented from protruding forwardly of the main body 100.

Specifically, as described above, the gas discharger 110 may be disposed at the front side of the main body 100. Furthermore, the coupling portion 150 may be curved so as to be recessed toward the module power supply 135. That is, the coupling portion 150 may be curved so as to be recessed rearward from one side thereof that is in contact with the inner circumferential surface of the main body 100 to the other side thereof that defines the gas discharge hole 113. Furthermore, the coupling auxiliary portion 170 may be curved so as to be recessed toward the module power supply 135. That is, the coupling auxiliary portion 170 may be curved so as to be recessed rearward from one side thereof that defines the gas discharge hole 113 to the other side thereof facing the module power supply 135. As a result, the probability that the user comes into contact with the coupling portion 150 and the coupling auxiliary portion 170 may be reduced, thereby reducing the risk of burns and injury.

Furthermore, the one side of the coupling auxiliary portion 170 that defines the gas discharge hole 113 may be disposed rearwardly of the other side of the coupling portion 150 that defines the gas discharge hole 113. That is, when viewing the main body 100 from the front, the coupling portion 150 and the coupling auxiliary portion 170 may be curved rearward while forming a continuous surface. Accordingly, when coupled with the main body 100, the diffuser 200 may be inserted into and coupled to the main body 100 via the coupling portion 150 and the coupling auxiliary portion 170. As a result, the diffuser 200 may increase the force of coupling with the main body 100.

In one example, the module power supply 135 may include a first power supply terminal 1351 having a first polarity to supply the power to the diffuser 200. Furthermore, the module power supply 135 may include a second power supply terminal 1353 having a second polarity different from the first polarity. That is, a (+) terminal and a (−) terminal may be required to supply the power. Accordingly, when the first power supply terminal 1351 is formed as the (+) terminal, the second power supply terminal 1353 may be formed as the (−) terminal. Conversely, when the first power supply terminal 1351 is formed as the (−) terminal, the second power supply terminal 1353 may be formed as the (+) terminal.

However, when the first power supply terminal 1351 and the second power supply terminal 1353 are in contact with each other, short circuits (meaning direct connection between two terminals or two points in an electric circuit without passing through a load) may occur. Accordingly, the hair dryer 10 according to one embodiment of the present disclosure may have the first power supply terminal 1351 and the second power supply terminal 1353 spaced apart from each other.

Specifically, the first power supply terminal 1351 may be disposed at the center of the gas discharger 110. The first power supply terminal 1351 may protrude forward to facilitate the contact with the diffuser 200. Furthermore, the second power supply terminal 1353 may be spaced apart from the first power supply terminal 1351 and may be formed in an annular shape to surround the first power supply terminal 1351. The second power supply terminal 1353 may protrude forward to facilitate the contact with the diffuser 200.

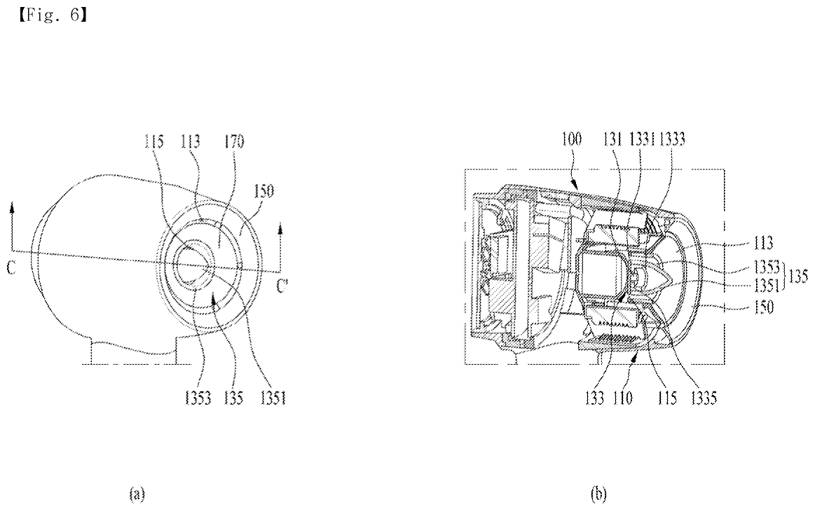

In one example, FIG. 6 is a view showing a main body having a gas discharge auxiliary hole defined therein according to an embodiment of the present disclosure. Referring to FIG. 6, the module power supply 135 may include a gas discharge auxiliary hole 115 defined between the first power supply terminal 1351 and the second power supply terminal 1353 to efficiently utilize an internal space of the main body 100 (a space of the gas discharger 110). Gas inside the hair dryer may be discharged to the outside via the gas discharge auxiliary hole 115 and the gas discharge hole 113. The user may dry the hair using gas discharged via the gas discharge auxiliary hole 115 and the gas discharge hole 113. The gas discharge auxiliary hole 115 may assist the gas discharge hole 113 to provide sufficient gas to the user. As a result, user's convenience may be increased. Furthermore, utilization efficiency of the internal space of the hair dryer 10 may be increased.

As described above, the hair dryer 10 according to one embodiment of the present disclosure may have a coupling portion 150 to facilitate the coupling of the diffuser 200. Furthermore, the module power supply 135 may supply the power to the diffuser 200 independently of the rotation direction of one surface where the diffuser 200 is coupled to the coupling portion 150. It is preferable that the diffuser 200 has an internal configuration corresponding thereto.

Accordingly, in the hair dryer 10 according to one embodiment of the present disclosure, the module power receiver 230 of the diffuser 200 may be disposed at a position corresponding to the module power supply 135.

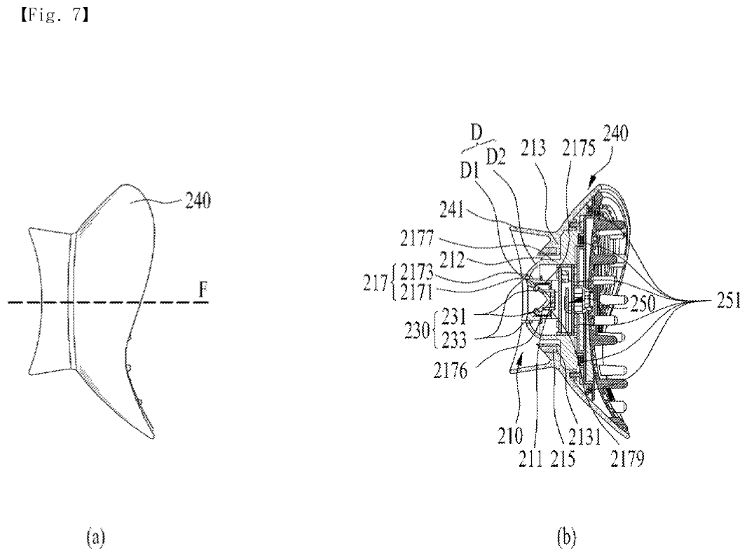

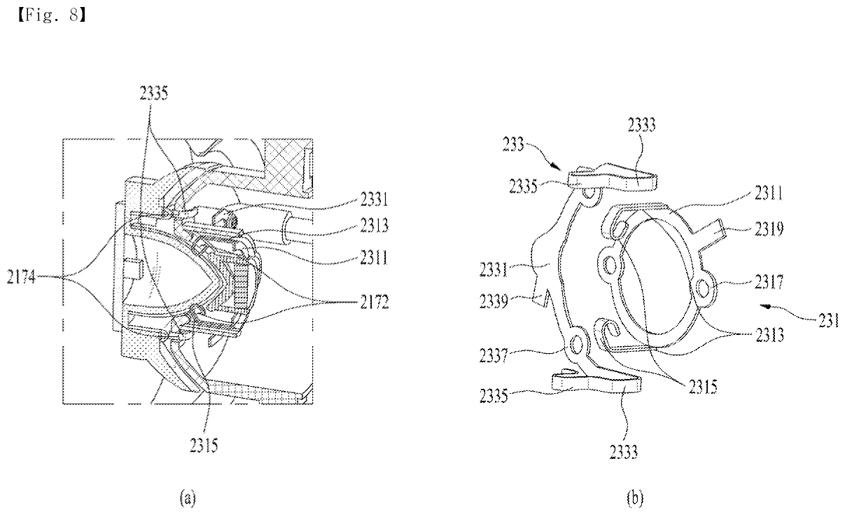

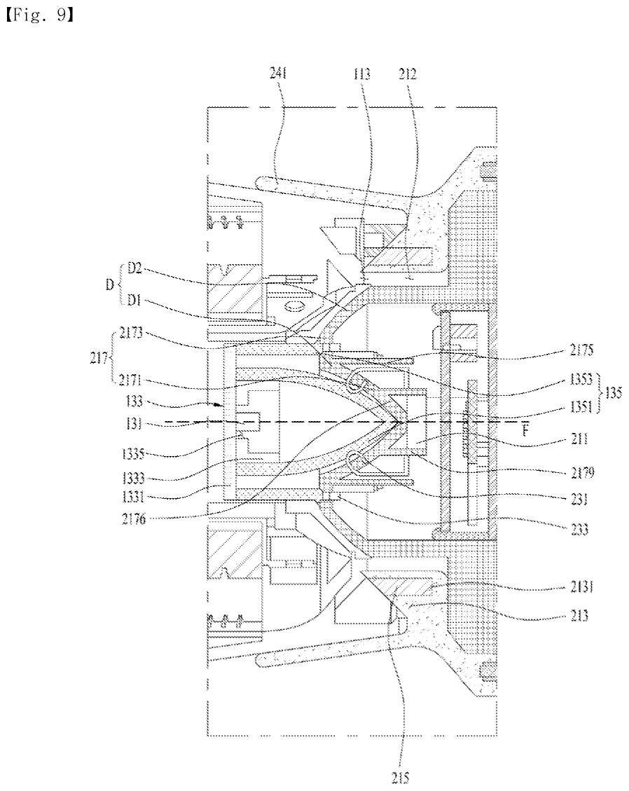

FIG. 7 is a view showing a diffuser according to an embodiment of the present disclosure. FIG. 8 is a view showing a module power receiver of a diffuser according to an embodiment of the present disclosure. FIG. 9 is a view showing a portion where a main body and a diffuser are coupled to each other according to an embodiment of the present disclosure.

Specifically, (a) in FIG. 7 is a perspective view of the diffuser, and (b) in FIG. 7 is a cross-sectional view of the diffuser. (a) in FIG. 8 is a cross-sectional view showing that the module power receiver is in contact with the module power supply, and (b) in FIG. 8 is a view showing the first power receiving terminal and the second power receiving terminal.

Referring to FIGS. 7 to 9, in the hair dryer 10 according to one embodiment of the present disclosure, the module power receiver 230 of the diffuser 200 may be disposed at a position corresponding to the module power supply 135.

Specifically, the diffuser 200 may include a housing 240 that forms an outer appearance thereof. The diffuser 200 may include a gas inlet 210 disposed at one side of the housing 240. The gas inlet 210 may be in communication with the gas discharger 110, so that gas may be introduced from the gas discharger 110. Furthermore, the diffuser 200 may include a module 250 disposed inside the housing 240. The module 250 may operate by receiving the power from the main body 100. That is, the module 250 may perform the scalp and hair care function using the LEDs and the scalp and hair care function using the anions described above.

The gas inlet 210 may include the module power receiver 230 disposed at a position corresponding to the module power supply 135. The module power receiver 230 may be in contact with the module power supply 135. That is, the module power receiver 230 may receive the power from the module power supply. Furthermore, the module power receiver 230 may transfer the received power to the module 250. Finally, the module 250 may receive the power for the additional functions.

Furthermore, the gas inlet 210 may further include a receiving portion 217 into which the module power receiver 230 may be received and fixed. When the contact between the module power receiver 230 and the module power supply 135 is not made or the contact is poor, the module 250 may not be able to perform the additional functions itself. Accordingly, the receiving portion 217 provides a great coupling force to the module power receiver 230 to facilitate the contact between the module power receiver 230 and the module power supply 135.

One surface D of the receiving portion 217 facing the module power supply 135 may be formed as a closed surface. Furthermore, the receiving portion 217 may have the other surface opposite to the one surface as an open surface. Thus, the module power receiver 230 may be easily received into and coupled to the receiving portion 217 via the other surface of the receiving portion 217.

Furthermore, the module power receiver 230 may come into contact with the module power supply 135 as one end thereof facing the module power supply 135 passes through the receiving portion 217. That is, the module power receiver 230 may come into contact with the module power supply 135 through the closed one surface of the receiving portion 217 facing the module power supply 135. As a result, the module power receiver 230 may receive great support force and coupling force by the receiving portion 217. Furthermore, exposure of the module power receiver 230 to the outside of the diffuser 200 may be prevented as much as possible. Furthermore, contact of the module power receiver 230 with heated gas may be prevented as much as possible. That is, durability of the module power receiver 230 may be improved.

In one example, as described above, the module power supply 135 may include the first power supply terminal 1351 having the first polarity and the second power supply terminal 1353 having the second polarity different from the first polarity. Accordingly, the module power receiver 230 may include a first power receiving terminal 231 disposed at a position corresponding to the first power supply terminal 1351. The first power receiving terminal 231 may be in contact with the first power supply terminal 1351. Furthermore, the module power receiver 230 may include a second power receiving terminal 233 disposed at a position corresponding to the second power supply terminal 1353. The second power receiving terminal 233 may be in contact with the second power supply terminal 1353. Thus, the module power receiver 230 may be connected to both the (−) pole and the (+) pole via the first power receiving terminal 231 and the second power receiving terminal 233 to receive the power from the module power supply 135.

However, when the first power receiving terminal 231 and the second power receiving terminal 233 are in contact with each other, the short circuits may occur. Accordingly, in the hair dryer 10 according to one embodiment of the present disclosure, the receiving portion 217 may receive the first power receiving terminal 231 and the second power receiving terminal 233 therein in a divided manner.

Specifically, the receiving portion 217 may include a first receiving portion 2171 that provides a space in which the first power receiving terminal 231 is received. Furthermore, the receiving portion 217 may include a second receiving portion 2173 defined to surround the first receiving portion 2171. The second receiving portion 2173 may be spaced apart from the first receiving portion 2171 in a radial direction of the gas inlet 210 to provide a space in which the second power receiving terminal 233 is received. Furthermore, the first receiving portion 2171 may include a first receiving circumferential wall 2175 extending from the one surface D1 of the first receiving portion 2171 facing the first power supply terminal 1351 to a position between the first power receiving terminal 231 and the second power receiving terminal 233. Accordingly, the first power receiving terminal 231 may be prevented from being in contact with the second power receiving terminal 233 by the first receiving circumferential wall 2175. As a result, the first power receiving terminal 231 may be prevented from being in contact with the second power receiving terminal 233 even when an extremal impact is applied, so that the short circuits may be effectively prevented.

Furthermore, the second receiving portion 2173 may include a second receiving circumferential wall 2177 spaced apart from the first receiving circumferential wall 2175 in the radial direction of the gas inlet 210 and surrounding the second power receiving terminal 233. That is, the second receiving circumferential wall 2177 may extend in a direction away from the second power supply terminal 1353 from one surface D2 of the second receiving portion 2173 facing the second power supply terminal 1353. Accordingly, the second power receiving terminal 233 may be positioned inside and coupled to the second receiving circumferential wall 2177. Thus, the second power receiving terminal 233 may be protected from the external impact via the second receiving circumferential wall 2177.

In one example, shapes of the first power receiving terminal 231 and the second power receiving terminal 233 respectively received in the first receiving portion 2171 and the second receiving portion 2173 may be determined to efficiently utilize an internal space of the diffuser 200. Specifically, the first power receiving terminal 231 may include a first receiving terminal main body 2311 formed in an annular shape. The first receiving terminal main body 2311 may face the one surface D1 of the first receiving portion 2171 facing the first power supply terminal 1351. Furthermore, the first receiving terminal main body 2311 may have a first fastening hole 2317 defined therein so as to be fixed to the first receiving portion 2171. The first fastening hole 2317 may be defined along a circumference of the first receiving terminal main body 2311. Furthermore, a plurality of first fastening holes 2317 may be defined to strongly couple the first power receiving terminal 231 to the first receiving portion 2171. The first receiving terminal main body 2311 may be fixed to the first receiving circumferential wall 2175 or the one surface D1 of the first receiving portion 2171 facing the first power supply terminal 1351 via the first fastening hole 2317 and a separate coupling member (not shown). Thus, the first power receiving terminal 231 may be easily coupled to the first receiving portion 2171 via the first fastening hole 2317, and may receive the great coupling force. Furthermore, the first power receiving terminal 231 may be prevented from being separated from the first receiving portion 2171 or from being deviated outwardly of the first receiving portion 2171 because of the external impact as much as possible.

Furthermore, the first power receiving terminal 231 may include a first connector 2319 such that the power may be transferred to the module 250. That is, the first connector 2319 may be connected to the module 250. Accordingly, the power transferred via the first power supply terminal 1351 and the first power receiving terminal 231 may be transferred to the module 250 via the first connector 2319.

The first power receiving terminal 231 may include a first receiving terminal extension 2313 extending from the first receiving terminal main body 2311 toward the first power supply terminal 1351. That is, the first receiving terminal main body 2311 may be disposed at one side close to the module 250 to supply the power to the module 250. Accordingly, the first receiving terminal extension 2313 may extend toward the first power supply terminal 1351 to be in contact with the first power supply terminal 1351 and receive the power from the first power supply terminal 1351. Furthermore, the first power receiving terminal 231 may include a first receiving terminal contact portion 2315 disposed at an end of the first receiving terminal extension 2313.

A plurality of first receiving terminal extensions 2313 may be disposed. Furthermore, the first receiving terminal extensions 2313 may be disposed symmetrically with respect to the center of the gas inlet 210. Accordingly, a plurality of first receiving terminal contact portions 2315 may also be disposed. Furthermore, the first receiving terminal contact portions 2315 may be disposed symmetrically with respect to the center of the gas inlet 210. As a result, the first power receiving terminal 231 may more easily come into contact with the first power supply terminal 1351. Furthermore, even when one first receiving terminal contact portion 2315 does not make contact with the first power supply terminal 1351 or the contact therebetween is poor, the first receiving terminal contact portion 2315 may receive the power from the first power supply terminal 1351 via contact between the other first receiving terminal contact portion 2315 and the first power supply terminal 1351.

Furthermore, the first receiving terminal contact portion 2315 may be curved toward the first receiving terminal main body 2311. That is, the first receiving terminal contact portion 2315 may be expanded or contracted by an external pressure. Furthermore, the first receiving terminal contact portion 2315 may return to an original state thereof when the external pressure disappears. Accordingly, the first receiving terminal contact portion 2315, as a portion in direct contact with the first power supply terminal 1351, may absorb the impact to some extent even when being in strong contact with the first power supply terminal 1351 when the diffuser 200 and the main body 100 are coupled to each other. As a result, a possibility of damage to the first receiving terminal contact portion 2315 resulted from the impact that may occur during the coupling may be reduced. That is, structural durability of the diffuser 200 may be increased. Furthermore, a size of an area where the first receiving terminal contact portion 2315 and the first power supply terminal 1351 are in contact with each other may be easily secured. This is because the size of the area in contact with the first power supply terminal 1351 may be increased as much as the first receiving terminal contact portion 2315 is curved. Thus, a probability that the contact between the first receiving terminal contact portion 2315 and the first power supply terminal 1351 is poor may be reduced.

In one example, the first receiving portion 2171 may include a first contact hole 2172 defined through the one surface D1 of the first receiving portion 2171 facing the first power supply terminal 1351. The first power receiving terminal 231 may be in contact with the first power supply terminal via the first contact hole 2172. That is, the one surface D1 of the first receiving portion 2171 facing the first power supply terminal 1351 may be formed as a closed surface except for the first contact hole 2172. Accordingly, the first receiving portion 2171 may easily support the first power receiving terminal 231 even when there is the external impact. Furthermore, the first receiving portion 2171 may limit a position of the first receiving terminal contact portion 2315 within a certain range via the first contact hole 2172. Thus, the first receiving terminal contact portion 2315 may stably receive the power from the first power supply terminal 1351.

Furthermore, the second power receiving terminal 233 may include a second receiving terminal main body 2331 disposed to surround at least a portion of the first power receiving terminal 231. That is, the second receiving terminal main body 2331 may be formed in an annular shape to correspond to the first receiving terminal main body 2311. Furthermore, the second receiving terminal main body 2331 may be disposed to surround at least a portion of the first power receiving terminal 231 so as to efficiently utilize the space inside the diffuser 200 and minimize a weight of the diffuser 200. It may be preferable that the second receiving terminal main body 2331 is at least semicircular such that second receiving terminal extensions 2333 are disposed symmetrically around a circumference thereof.

The second receiving terminal main body 2331 may face the one surface D2 of the second receiving portion 2173 facing the second power supply terminal 1353. Furthermore, the second receiving terminal main body 2331 may have a second fastening hole 2337 defined therein so as to be fixed to the second receiving portion 2173. The second fastening hole 2337 may be defined along the circumference of the second receiving terminal main body 2331. Furthermore, the plurality of second fastening holes 2337 may be defined to strongly couple the second power receiving terminal 233 to the second receiving portion 2173. The second receiving terminal main body 2331 may be fixed to the second receiving circumferential wall 2177 or the one surface D2 of the second receiving portion 2173 facing the second power supply terminal 1353 via the second fastening hole 2337 and a separate coupling member. Thus, the second power receiving terminal 233 may be easily coupled to the second receiving portion 2173 via the second fastening hole 2337, and may receive the strong coupling force. Furthermore, the second power receiving terminal 233 may be prevented from being separated from the second receiving portion 2173 or from being deviated outwardly of the second receiving portion 2173 by the external impact as much as possible.

Furthermore, the second power receiving terminal 233 may include a second connector 2339 such that the power may be transferred to the module 250. That is, the second connector 2339 may be connected to the module 250. Accordingly, the power transferred via the second power supply terminal 1353 and the second power receiving terminal 233 may be transferred to the module 250 via the second connector 2339.

The second power receiving terminal 233 may include a second receiving terminal extension 2333 extending from the second receiving terminal main body 2331 toward the second power supply terminal 1353. That is, the second receiving terminal main body 2331 may be disposed at one side close to the module 250 to supply the power to the module 250. Accordingly, the second receiving terminal extension 2333 may be in contact with the second power supply terminal 1353 and extend toward the second power supply terminal 1353 to receive the power from the second power supply terminal 1353. Furthermore, the second power receiving terminal 233 may include a second receiving terminal contact portion 2335 disposed at an end of the second receiving terminal extension 2333.

A plurality of second receiving terminal extensions 2333 may be disposed. Furthermore, the second receiving terminal extensions 2333 may be disposed symmetrically with respect to the center of the gas inlet 210. Accordingly, a plurality of second receiving terminal contact portions 2335 may also be disposed. Furthermore, the second receiving terminal contact portions 2335 may be disposed symmetrically with respect to the center of the gas inlet 210. As a result, the second power receiving terminal 233 may more easily come into contact with the second power supply terminal 1353. Furthermore, even when one second receiving terminal contact portion 2335 does not make contact with the second power supply terminal 1353 or the contact therebetween is poor, the second receiving terminal contact portion 2335 may receive the power from the second power supply terminal 1353 via contact between the other second receiving terminal contact portion 2335 and the second power supply terminal 1353.

Furthermore, the second receiving terminal contact portion 2335 may be curved toward the second receiving terminal main body 2331. That is, the second receiving terminal contact portion 2335 may be expanded or contracted by an external pressure. Furthermore, the second receiving terminal contact portion 2335 may return to an original state thereof when the external pressure disappears. Accordingly, the second receiving terminal contact portion 2335, as a portion in direct contact with the second power supply terminal 1353, may absorb the impact to some extent even when being in strong contact with the second power supply terminal 1353 when the diffuser 200 and the main body 100 are coupled to each other. As a result, a possibility of damage to the second receiving terminal contact portion 2335 resulted from the impact that may occur during the coupling may be reduced. That is, structural durability of the diffuser 200 may be increased. Furthermore, a size of an area where the second receiving terminal contact portion 2335 and the second power supply terminal 1353 are in contact with each other may be easily secured. This is because the size of the area in contact with the second power supply terminal 1353 may be increased as much as the second receiving terminal contact portion 2335 is curved. Thus, a probability that the contact between the second receiving terminal contact portion 2335 and the second power supply terminal 1353 is poor may be reduced.

In one example, the second receiving portion 2173 may include a second contact hole 2174 defined through the one surface D2 of the second receiving portion 2173 facing the second power supply terminal 1353. The second power receiving terminal 233 may be in contact with the second power supply terminal via the second contact hole 2174. That is, the one surface D2 of the second receiving portion 2173 facing the second power supply terminal 1353 may be formed as a closed surface except for the second contact hole 2174. Accordingly, the second receiving portion 2173 may easily support the second power receiving terminal 233 even when there is the extremal impact. Furthermore, the second receiving portion 2173 may limit a position of the first receiving terminal contact portion 2315 within a certain range via the second contact hole 2174. Thus, the second receiving terminal contact portion 2335 may stably receive the power from the second power supply terminal 1353.

In one example, as described above, the plurality of first receiving terminal contact portions 2315 may be disposed. Furthermore, a plurality of second receiving terminal contact portions 2335 may be disposed. That is, the first receiving terminal contact portion 2315 may be disposed along a circumference of the first receiving portion 2171. Furthermore, the second receiving terminal contact portion 2335 may be disposed along a circumference of the second receiving portion 2173. Furthermore, the first receiving terminal contact portion 2315 and the second receiving terminal contact portion 2335 may be disposed side by side along the radial direction of the gas inlet 210. That is, an angle formed by the first receiving terminal contact portion 2315 and an angle formed by the second receiving terminal contact portion 2335 may be the same with respect to a virtual line F passing through the center of the gas inlet 210 and heading toward the module power supply 135. That is, one first receiving terminal contact portion 2315 and one second receiving terminal contact portion 2335 may form one group. Furthermore, the other first receiving terminal contact portion 2315 and the other second receiving terminal contact portion 2335 may form another group. The one group and the other group may be disposed symmetrically with respect to the virtual line F.

Accordingly, even when rotation of the diffuser 200 occurs when the hair dryer 10 is used, the first power supply terminal 1351 and the second power supply terminal 1353 may come into contact with at least one of the one group and the other group. That is, the module power receiver 230 may continuously receive the power from the module power supply 135 even when the rotation of the diffuser 200 occurs.

As a result, the diffuser 200 may be stably supplied with the power. Furthermore, the user may stably use the additional functions of the diffuser 200 via the stable power supply of the diffuser 200.

Furthermore, the diffuser 200 may be rotatably coupled to the main body 100 with the virtual line F passing through the center of the gas inlet 210 and heading toward the module power supply 135 as a rotational axis. That is, the diffuser 200 may be coupled to the main body 100 regardless of a coupling direction (a rotation direction using the virtual line passing through the center of the diffuser as the rotation axis) of one surface where the diffuser is coupled to the hair dryer. Furthermore, the diffuser 200 may be constructed to be rotatable using the virtual line F as the rotation axis after being coupled to the main body 100. Furthermore, the diffuser 200 may continuously receive the power from the module power supply 135 even when the diffuser 200 rotates.

In one example, it may be preferable that a structure of the first power supply terminal 1351 is set to efficiently utilize a space inside the main body 100 while preventing contact with the second power supply terminal 1353 as much as possible.

Referring to FIGS. 1 and 5, accordingly, in the hair dryer 10 according to one embodiment of the present disclosure, the closer the first power supply terminal 1351 is to the first receiving portion 2171, the smaller the diameter thereof. That is, the diameter of the first power supply terminal 1351 may decrease as it extends forward. The first power supply terminal 1351 may be formed in a cone shape.

Furthermore, the first receiving portion 2171 may include a receiving recessed portion 2176 recessed to correspond to the first power supply terminal 1351 from the one surface D1 of the first receiving portion 2171 facing the first power supply terminal 1351. That is, a diameter of the receiving recessed portion 2176 may decrease as a distance from the first power supply terminal 1351 increases. The receiving recessed portion 2176 may be formed in a cone shape.

At least a portion of the first power supply terminal 1351 may be inserted into the receiving recessed portion 2176. Furthermore, the first power supply terminal 1351 may pass through the receiving recessed portion 2176 and come into contact with the first receiving terminal contact portion 2315. The receiving recessed portion 2176 may have the above-described first contact hole 2172. Accordingly, the first power supply terminal 1351 may supply the power to the module 250 via the first receiving terminal contact portion 2315. As a result, while the first power supply terminal 1351 is prevented from being in contact with the second power supply terminal 1353 as much as possible, an efficiency of the internal space of the hair dryer 10 may be increased. Furthermore, as at least the portion of the first power supply terminal 1351 is inserted into the receiving recessed portion 2176, the contact thereof with the first receiving terminal contact portion 2315 may be continuously maintained by the receiving recessed portion 2176 even when there is the external impact. Furthermore, a coupling force of the diffuser 200 to the main body 100 may be increased by the first power supply terminal 1351 and the receiving recessed portion 2176. Thus, the diffuser 200 may be prevented from being separated from the main body 100 as much as possible.

In one example, in the hair dryer 10, to supply the power from the module power supply 135 to the module power receiver 230, the controller 700 must recognize the contact between the diffuser 200 and the main body 100 and supply the power.

Referring back to FIGS. 1 and 5, accordingly, the hair dryer 10 according to one embodiment of the present disclosure may include the sensor assembly 130.

The module power supply 135 may supply the power to the diffuser 200 regardless of the coupling direction (the rotation direction using the virtual line passing through the center of the diffuser as the rotation axis) of the one surface where the diffuser is coupled to the hair dryer.

Accordingly, the sensor assembly 130 may recognize the coupling of the diffuser 200 and the main body 100 by sensing the magnetism of the diffuser 200. Furthermore, it is preferable that the sensor assembly 130 recognizes the coupling of the diffuser 200 and the main body 100 regardless of the coupling direction (the rotation direction using the virtual line passing through the center of the diffuser as the rotation axis) of the one surface where the diffuser is coupled to the hair dryer.

The sensor assembly 130 may be disposed at the center of the gas discharger 110. Specifically, the sensor assembly 130 may be disposed inside the first power supply terminal 1351. That is, the first power supply terminal 1351 may serve to protect the sensor assembly 130 while supplying the power to the first power receiving terminal 231.

Furthermore, the diffuser 200 may include a recognizing magnetic body 211 that has magnetism such that the sensor assembly 130 may sense the magnetism. That is, the recognizing magnetic body 211 may be disposed to correspond to the sensor assembly 130 at a center of the first receiving portion 2171. That is, when the main body 100 and the diffuser 200 are coupled to each other, the one surface where the main body 100 and the diffuser 200 face each other may be constant. Furthermore, even when being rotated while being coupled with the main body 100, the diffuser 200 may maintain the coupling, and the sensor assembly 130 and the recognizing magnetic body 211 may be remained at the same positions.

Accordingly, the sensor assembly 130 may face the recognizing magnetic body 211 regardless of the coupling direction (the rotation direction using the virtual line passing through the center of the diffuser as the rotation axis) of the one surface where the diffuser is coupled to the hair dryer. That is, when the diffuser 200 is coupled to the main body 100, the sensor assembly 130 may always sense the magnetism of the recognizing magnetic body 211.

Accordingly, the sensor assembly 130 may easily sense the coupling of the diffuser 200 and the main body 100, and the module power supply 135 may easily supply the power to the diffuser 200. That is, the user may conveniently use the additional functions of the diffuser 200.

Furthermore, it may be preferable that the recognizing magnetic body 211 is prevented from being in contact with the first power receiving terminal 231. That is, electrical properties and magnetic properties may affect each other. When the recognizing magnetic body 211 and the first power receiving terminal 231 are in contact with each other, it may be difficult for the sensor assembly 130 to sense the coupling of the diffuser 200 and the main body 100. Furthermore, when the recognizing magnetic body 211 and the first power receiving terminal 231 are in contact with each other, it may be difficult for the module power supply 135 to supply the power to the diffuser 200.

Accordingly, the diffuser 200 may further include a recognizing magnetic body receiving portion 2179 that provides a space in which the recognizing magnetic body 211 is received. The recognizing magnetic body receiving portion 2179 may be disposed at the center of the first receiving portion 2171 such that the sensor assembly 130 may always sense the magnetism of the recognizing magnetic body 211 when the diffuser 200 and the main body 100 are coupled to each other. Furthermore, the recognizing magnetic body receiving portion 2179 may be disposed between the first power receiving terminal 231 and the recognizing magnetic body 211. That is, the contact of the recognizing magnetic body 211 with the first power receiving terminal 231 may be prevented by the recognizing magnetic body receiving portion 2179.

In one example, the diffuser 200 may be inserted into and coupled to the main body 100. Furthermore, a portion of the main body 100 may be inserted into and coupled to the diffuser 200. The diffuser 200 and the main body 100 may be constructed to be inserted into each other, so that a coupling strength may be increased. However, when the diffuser 200 and the main body 100 are coupled to each other only by the insertion, the user may feel uncomfortable. That is, when the diffuser 200 and the main body 100 are coupled to each other in a tight fit manner, a strong coupling force may be obtained, but the user may have difficulty in mounting and dismounting the diffuser 200. Furthermore, when the diffuser 200 and the main body 100 are coupled to each other in a loose fit manner, the diffuser 200 may be removed with only a small external impact.

Accordingly, the hair dryer 10 according to one embodiment of the present disclosure may include the coupling magnetic body 215 for coupling the diffuser 200 and the main body 100 to each other.

Referring back to FIGS. 7 to 9, the gas inlet 210 may include a main body coupling portion 213 formed in an annular shape along the circumference of the gas inlet 210 to surround the receiving portion 217. The main body coupling portion 213 may be disposed at a position corresponding to the coupling portion 150. That is, when the diffuser 200 is coupled to the main body 100, the main body coupling portion 213 may face the coupling portion 150. In other words, the coupling portion 150 and the main body coupling portion 213 may be formed in the annular shape to allow the diffuser to be coupled regardless of the coupling direction (the rotation direction using the virtual line passing through the center of the diffuser as the rotation axis) of the one surface where the diffuser is coupled to the hair dryer, when the diffuser 200 and the main body 100 are coupled to each other.

Furthermore, the gas inlet 210 may include the coupling magnetic body 215 formed in the annular shape in the main body coupling portion 213. The coupling magnetic body 215 may be coupled to the coupling portion 150 by a magnetic force. Accordingly, the coupling portion 150 may be made of a material such as metal so as to be coupled to the coupling magnetic body 215 by the magnetic force. As the coupling portion 150 is formed in the annular shape, it may be preferable that the coupling magnetic body 215 is formed in the corresponding annular shape so as to be coupled to the coupling portion 150 in a large area.

The main body coupling portion 213 may include a coupling magnetic body receiving portion 2131 defined as one surface of the main body coupling portion 213 facing the coupling portion 150 is recessed. The coupling magnetic body 215 may be received in the coupling magnetic body receiving portion 2131. That is, the coupling magnetic body 215 may be inserted into and coupled to the coupling magnetic body receiving portion 2131. Furthermore, the coupling magnetic body 215 may be coupled to the coupling magnetic body receiving portion 2131 using an adhesive or the like. Accordingly, the coupling magnetic body 215 may be fixed in position by the coupling magnetic body receiving portion 2131, and exposure thereof to the external impact may be minimized. That is, a possibility of breakage of the coupling magnetic body 215 may be reduced.

In one example, the diffuser 200 may further include a receiving coupling portion 241 to have a great coupling force with the main body 100. That is, the housing 240 may include a receiving coupling portion 241 extending from an outer circumferential surface of the main body coupling portion 213 toward the main body 100. The receiving coupling portion 241 may be constructed to receive the main body 100 therein. That is, the main body coupling portion 213 may be coupled to the main body 100 such that the receiving coupling portion 241 surrounds the main body 100. As a result, the diffuser 200 may receive the great coupling force with the main body 100 via the receiving coupling portion 241. Furthermore, the receiving coupling portion 241 may protect the inside of the main body 100 where the sensor assembly 130, the temperature adjust unit 120, and the like are disposed from the external impact.

As described above, the recognizing magnetic body 211 and the coupling magnetic body 215 may be formed to have the magnetism. However, it may be preferable that the sensor assembly 130 senses only the magnetism of the recognizing magnetic body 211 to accurately sense the coupling of the diffuser 200 and the main body 100. Accordingly, the recognizing magnetic body 211 may have first magnetism. Furthermore, the coupling magnetic body 215 may have second magnetism different from the first magnetism. The first magnetism may be of an N pole or an S pole. The second magnetism may be of the S pole or the N pole opposite to the first magnetism. That is, when the recognizing magnetic body 211 has the S pole, the sensor assembly 130 may recognize only the S pole. Thus, the sensor assembly 130 may more easily sense the magnetism of the recognizing magnetic body 211. Furthermore, the sensor assembly 130 may more easily and accurately sense the coupling of the diffuser 200 and the main body 100.

Furthermore, in the hair dryer 10 according to one embodiment of the present disclosure, the coupling auxiliary portion 170 may be non-magnetic to facilitate the sensing, by the sensor assembly 130, of the magnetism of the recognizing magnetic body 211.

Referring to FIG. 7, when the diffuser 200 and the main body 100 are coupled to each other, the coupling auxiliary portion 170 may be positioned between the sensor assembly 130 and the main body coupling portion 213 having the coupling magnetic body 215 of the gas discharger 110. Accordingly, the coupling auxiliary portion 170 may be non-magnetic to prevent the magnetism of the coupling magnetic body 215 from reaching the sensor assembly 130 as much as possible. Furthermore, because the coupling auxiliary portion 170 is prevented from coupling with the coupling magnetic body 215, when the diffuser 200 is coupled to the main body 100, the coupling of the main body coupling portion 213 and the coupling portion 150 may be more easily performed by the coupling magnetic body 215.

Accordingly, the user may more easily couple the diffuser 200 and the main body 100 to each other, and the sensor assembly 130 may more easily sense the magnetism of the recognizing magnetic body 211 by the auxiliary coupling portion 170. Furthermore, as the controller 700 may easily recognize the coupling of the diffuser 200 and the main body 100, the additional functions of the diffuser 200 may be performed more easily.

In one example, as described above, the diffuser 200 may be equipped with the additional functions and may provide the additional functions to the user when coupled to the main body 100. That is, the hair dryer 10 according to one embodiment of the present disclosure may provide the scalp and hair care function using LEDs via the diffuser 200.

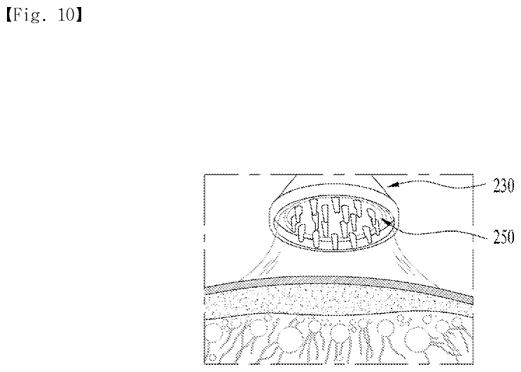

FIG. 10 is a view showing a hair dryer in which additional functions are performed by a diffuser according to an embodiment of the present disclosure.

Referring to FIGS. 3, 4, 7, and 10, the diffuser 200 may further include the module 250 disposed inside the housing 240. The module 250 may include a plurality of lamps 251. The lamps 251 may be spaced apart from a center of the module 250 in a radial direction of the module 250. Accordingly, light emitted from the lamps 251 may be radiated in a wide range via the other side of the housing 240. That is, the lamp 251 may radiate light toward a wide area size of the user's hair and scalp. As a result, the user may efficiently care for the hair and the scalp. The lamps 251 may be constructed as the LEDs. However, the present disclosure may not be limited thereto and the lamps may be formed in various shapes for the hair and scalp care.

Furthermore, only the scalp and hair care function using the LEDs of module 250 has been described, but the additional functions of the module 250 may be various functions including the scalp and hair care function using anions.

Furthermore, the housing 240 may have a gas flow forming unit 260 attached to the other side thereof through which gas is discharged. That is, the gas flow forming unit 260 may provide the smooth flow to the user. Specifically, the gas flow forming unit 260 may have a plurality of annular frames 261 spaced apart from each other in a radial direction of the gas flow forming unit 260. Accordingly, the gas flow forming unit 260 may have a plurality of outlets 263 in the radial direction of the gas flow forming unit 260. Thus, the user may receive the smooth flow of gas via the plurality of outlets 263.

Furthermore, the gas flow forming unit 260 may further include a support rib 265 disposed between the annular frames 261 and connected to the annular frames 261 on both sides. Thus, structural stability of the gas flow forming unit 260 may be increased via the support rib 265.

Although representative embodiments of the present disclosure have been described in detail above, those of ordinary skill in the technical field to which the present disclosure belongs will understand that various modifications are possible with respect to the above-described embodiment without departing from the scope of the present disclosure. Therefore, the scope of the present disclosure should not be limited to the described embodiment, and should be defined not only by the claims described below, but also by these claims and equivalents thereof.

What is claimed is:

1. A hair dryer comprising:
a main body having a gas discharger configured to discharge gas; and
a handle disposed on the main body,
wherein the gas discharger includes:
a module power supply located at a center of the gas discharger and configured to supply power to a diffuser coupled to the main body; and
a coupling portion surrounding the module power supply and formed in an annular shape along a circumference of the gas discharger,
wherein the diffuser is coupled to the main body via the coupling portion,
wherein the module power supply faces the diffuser and is in contact with the diffuser to supply power to the diffuser.

2. The hair dryer of claim 1, wherein the gas discharger further includes:
a coupling auxiliary portion disposed between the coupling portion and the module power supply and formed in an annular shape to surround the module power supply; and
a gas discharge hole defined between the coupling auxiliary portion and the coupling portion, wherein gas is discharged via the gas discharge hole.

3. The hair dryer of claim 1, wherein the gas discharger is disposed at a front side of the main body,
wherein the module power supply includes:
a first power supply terminal disposed at the center of the gas discharger and protruding forward; and
a second power supply terminal spaced apart from the first power supply terminal and formed in an annular shape to surround the first power supply terminal,
wherein the first power supply terminal has a first polarity, and the second power supply terminal has a second polarity different from the first polarity.

4. The hair dryer of claim 3, wherein the module power supply further includes a gas discharge auxiliary hole defined between the first power supply terminal and the second power supply terminal, wherein gas is discharged via the gas discharge auxiliary hole.

5. The hair dryer of claim 1, wherein the diffuser includes:
a housing forming an outer appearance of the diffuser;
a gas inlet disposed at one side of the housing, wherein gas is introduced into the gas inlet from the gas discharger; and
a module disposed inside the housing and operated by receiving power from the module power supply,
wherein the gas inlet includes:
a module power receiver in contact with the module power supply to transmit received power to the module; and
a receiving portion disposed at a center of the gas inlet, wherein the module power receiver is received in the receiving portion,
wherein the module power receiver has an end facing the module power supply, wherein the end extends through the receiving portion to be in contact with the module power supply.

6. The hair dryer of claim 5, wherein the module power supply includes:
a first power supply terminal disposed at the center of the gas discharger, protruding toward the receiving portion, and having a first polarity; and
a second power supply terminal spaced apart from the first power supply terminal, formed in an annular shape to surround the first power supply terminal, and having a second polarity different from the first polarity,
wherein the module power receiver includes:
a first power receiving terminal disposed at a position corresponding to the first power supply terminal and in contact with the first power supply terminal; and
a second power receiving terminal disposed at a position corresponding to the second power supply terminal and in contact with the second power supply terminal.

7. The hair dryer of claim 6, wherein the receiving portion further includes:
a first receiving portion providing a space for the first power receiving terminal to be received; and
a second receiving portion disposed to surround the first receiving portion and providing a space for the second power receiving terminal to be received,
wherein the first receiving portion includes a first receiving circumferential wall extending from one surface of the first receiving portion facing the first power supply terminal to a position between the first power receiving terminal and the second power receiving terminal,
wherein the first power receiving terminal is prevented from being in contact with the second power receiving terminal by the first receiving circumferential wall.

8. The hair dryer of claim 7, wherein the first power supply terminal decreases in a diameter as a distance to the first receiving portion is reduced,
wherein the first receiving portion includes a receiving recessed portion recessed to correspond to the first power supply terminal from the one surface of the first receiving portion facing the first power supply terminal,
wherein at least a portion of the first power supply terminal is inserted into the receiving recessed portion.

9. The hair dryer of claim 7, wherein the first power receiving terminal includes:
a first receiving terminal main body formed in an annular shape;
a first receiving terminal extension extending from the first receiving terminal main body toward the first power supply terminal; and
a first receiving terminal contact portion formed to be curved from an end of the first receiving terminal extension toward the first receiving terminal main body,
wherein the first receiving portion includes a first contact hole defined through the one surface of the first receiving portion facing the first power supply terminal,
wherein the first receiving terminal contact portion is in contact with the first power supply terminal via the first contact hole.

10. The hair dryer of claim 7, wherein the second power receiving terminal includes:
a second receiving terminal main body disposed to surround at least a portion of the first power receiving terminal;
a second receiving terminal extension extending from the second receiving terminal main body toward the second power supply terminal; and
a second receiving terminal contact portion formed to be curved from an end of the second receiving terminal extension toward the second receiving terminal main body,
wherein the second receiving portion includes a second contact hole defined through one surface of the second receiving portion facing the second power supply terminal,
wherein the second receiving terminal contact portion is in contact with the second power supply terminal via the second contact hole.

11. The hair dryer of claim 7, wherein the gas discharger further includes a sensor assembly disposed inside the first power supply terminal and configured to sense coupling of the diffuser and the main body by sensing magnetism generated by the diffuser,
wherein the diffuser includes:
a recognizing magnetic body receiving portion disposed at a center of the first receiving portion; and
a recognizing magnetic body received in the recognizing magnetic body receiving portion and having magnetism,
wherein the recognizing magnetic body receiving portion is disposed between the first power receiving terminal and the recognizing magnetic body,
wherein the recognizing magnetic body is prevented from being in contact with the first power receiving terminal by the recognizing magnetic body receiving portion,
wherein the sensor assembly senses magnetism of the recognizing magnetic body.

12. The hair dryer of claim 7, wherein the first power receiving terminal includes a plurality of first receiving terminal contact portions disposed along a circumference of the first receiving portion and in contact with the first power supply terminal,
wherein the second power receiving terminal includes a plurality of second receiving terminal contact portions disposed along a circumference of the second receiving portion and in contact with the second power supply terminal,
wherein the first receiving terminal contact portions and the second receiving terminal contact portions are disposed side by side along a radial direction of the gas inlet.

13. The hair dryer of claim 5, wherein the diffuser is coupled to the main body to be rotatable using a virtual line passing through the center of the gas inlet and heading toward the module power supply as a rotation axis.

14. The hair dryer of claim 5, wherein the module includes a plurality of lamps spaced apart from a center of the module in a radial direction of the module,
wherein the lamp is turned on by receiving power from the module power receiver.

15. The hair dryer of claim 5, wherein the gas inlet further includes:
a main body coupling portion formed in an annular shape along a circumference of the gas inlet to surround the receiving portion and disposed at a position corresponding to the coupling portion; and
a coupling magnetic body formed in an annular shape in the main body coupling portion and coupled to the coupling portion by a magnetic force.

16. The hair dryer of claim 15, wherein the main body coupling portion includes a coupling magnetic body receiving portion defined as one surface of the main body coupling portion facing the coupling portion is recessed,
wherein the coupling magnetic body receiving portion receives the coupling magnetic body therein.
